(19) United States
(12) Patent Application Publication
(10) Pub. No.: US 2004/0231488 A1
(43) Pub. Date: Nov. 25, 2004

(54) Device for the generation of a retutn force on a tremolo for a string instrument

(76) Inventor: Harald Hontsch, Rosrath (DE)

Correspondence Address: Anthony Niewyk, Baker & Daniels, Suite 800, 111 East Wayne Street, Fort Wayne, IN, 46802, US

(21) Appl. No.: 10/257,122

(22) PCT Filed: Apr. 4, 2001
(86) PCT No.: PCT/EP01/03796

(30) Foreign Application Priority Data
Apr. 11, 2000 (JP) 100 17 872.3

(51) Int. Cl. G10D 3/00

(52) U.S. Cl. 84/313

(57) ABSTRACT

In an arrangement (10) for producing a restoring force in the case of a tremolo (5) for a stringed instrument (1) with a basic body (3) and strings (4) using at least one restoring element (17), the at least one restoring element (17) is arranged in an adjustable manner in the basic body (3) of the stringed instrument (1) outside the playing region of the strings (4).

### BACKGROUND OF THE INVENTION

The invention relates to an arrangement for producing a restoring force in the case of a tremolo for a stringed instrument with a basic body and strings using at least one restoring element.

Stringed instruments, in particular plucked instruments such as electric guitars, are often provided with a tremolo. This mechanical device serves to allow the player of the instrument, in particular the guitarist, to use hand-lever actuation to change the string tensioning and thus the pitch which can be played on the strings. It is known here to provide tension springs which are directed counter to the string tensioning and, without the hand lever being actuated, return the strings to the originally tuned pitch. Such an arrangement is known, for example, from U.S. Pat. No. 4,171,661, which discloses an arrangement in the case of which the tremolo is connected to a spring-actuating lever which, for its part, is connected firmly to the tension spring. The tension spring, at its other end, is secured on the underside of the basic body of the instrument, in a recess provided there, such that it can be adjusted by means of a screw. It is oriented in the direction of the neck of the instrument, that is to say in the direction of the playable strings. The base plate of the tremolo is mounted such that it can be tilted via a screw, which can be screwed into the basic body of the instrument and thus adjusted, the screw being arranged at a different end of the base plate from the spring-actuating lever connected to the tension spring. The ends of the strings are fastened at that end of the base plate of the tremolo which is oriented away from the neck of the instrument, and are clamped into said tremolo such that the pitch can be changed by virtue of the tremolo base plate being tilted.

Another possible means for fastening the strings in the tremolo is disclosed in U.S. Pat. No. 4,497,236. In the case of this arrangement, a tension spring oriented in the direction of the strings and of the neck of the instrument is likewise fastened on a spring-actuating lever of the tremolo.

In the case of both embodiments of the tremolo according to U.S. Pat. No. 4,171,661 and U.S. Pat. No. 4,497,236, the tension springs, located in the basic body, are arranged beneath, and parallel to, the strings, directed counter to the tensioning of the latter, at an angle a of 180° thereto. In the case of instruments, e.g. guitars, with an increased tonal playing range, that is to say more frets, and a longer instrument neck projecting into the basic body, this tension spring or, in the case of a spring assembly being provided, this spring assembly obstructs the playing of the high pitches since the spring assembly is in the way of the playing hand.

The object of the present invention is thus to provide an arrangement which is intended for producing a restoring force in the case of a tremolo for a stringed instrument and which avoids this disadvantage and which also allows unobstructed playing of an increased tonal playing range.

### SUMMARY OF THE INVENTION

This object is achieved by an arrangement wherein at least one restoring element is arranged in an adjustable manner in the basic body of the stringed instrument outside the playing region of the strings.

The invention thus provides an arrangement in the case of which it is advantageously possible for any desired, even very much increased, tonal playing range of the instrument to be played without obstruction. It is also intended to achieve an improvement in sound. Since, in contrast to the known arrangements, the at least one restoring element is not arranged beneath the playable length of the strings, but rather in that region within the basic body in which either the strings are fastened on the tremolo or are not present at all, the playing of the strings is not obstructed. In this case, the restoring element or elements is or are provided at a remote location in particular from a neck of the instrument, as a result of which the restoring elements are neither fitted in the often narrow neck nor is the playing hand obstructed. The entire arrangement may be integrated in the basic body of the instrument, which is larger in any case. Moreover, on account of the arrangement being provided, a base plate of the tremolo may be incorporated at a lower level in the basic body of the instrument, as a result of which the overall tremolo structure together with the arrangement is less disruptive to the player and the risk of injury on account of parts projecting beyond the surface of the instrument is also reduced. The tremolo and instrument form a unit.

It is preferable for the at least one restoring element to be essentially arranged in the direction of the strings. Optimum force and string-tensioning transmission can take place as a result, the restoring element or elements arranged in the direction of the strings constituting, in principle, an extension of the latter in a different plane. The flow of force is not thereby reversed, as is the case with the known arrangements, but rather remains in its direction of flow defined by the strings and can thus be transmitted in optimum fashion.

Alternatively, it is also possible for the restoring elements to be arranged essentially transversely, or at a predetermined angle, to the direction of the strings, in particular at an angle α of 0°<α<180°. There is no need here for any greater level of mechanical structural outlay than in the case of the at least one restoring element being provided essentially in the direction of the strings. This is preferably because the restoring element or elements is or are operatively connected to the tensioning of the strings via a force-deflecting device. On the one hand, this isolates the strings from the restoring element or elements, since the restoring elements can be arranged in a different plane. On the other hand, however, it is advantageously possible for the restoring elements to be arranged in any desired direction in the basic body, in dependence on the construction of the latter. It is always possible here, on account of the force-deflecting device, for the flow of force to be directed in a precisely defined and maintainable manner.

It is particularly preferred here for the force-deflecting device to have a cable-pull mechanism in combination with at least one deflecting device. It is thus possible for the cable or cables to be positioned around the deflecting device(s) and to be guided at a predeterminable angle into the deflecting device(s) and out of the same again. This also provides the advantage of the at least one restoring element, together with the cable-pull mechanism, being positioned in a fixed and precisely determinable and securable manner. It is preferably possible for one deflecting device to be connected to a plurality of restoring elements. The individual restoring elements thus assist one another in respect of the force which they exert, and a force direction can be defined more precisely. Moreover, redundancy is created.

It is particularly preferable for the deflecting device to have low-friction deflection of the cable-pull mechanism, in particular using a running bearing, in particular a ball bearing. This advantageously provides low-friction mounting and the lowest possible level of running losses. As a result, when the tremolo-actuating handle is released, the restoring elements can take effect directly, without delay times or jamming, and restore the tremolo. A delay or losses in the region of the deflection of the cable-pull mechanism on the deflecting device thus advantageously do not occur.

The deflecting angle of the cable pull, this angle being produced via the deflecting device, may preferably be selected in dependence on the shape of the basic body of the stringed instrument. It is thus possible, for example in the case of a guitar, to select that position within the basic body, but advantageously essentially not beneath the strings, in which the arrangement does not adversely affect the body of the instrument and/or the playing properties and/or the playability of the instrument. Since the restoring device can be arrested in the basic body without any significant outlay, it is also readily possible for it to be changed in position within the basic body. Use is preferably made, for this purpose, of an adjusting device for arresting purposes in the basic body. This arresting device is preferably accessible from the outside, that is to say, if required, it can easily be set by virtue of the necessary tensile force of the restoring element or elements being adjusted. Use is particularly preferably made, for this purpose, of a tensioning or adjusting screw which is mounted in the basic body of the stringed instrument and via which the restoring element or elements can be adjusted on one side. It is also possible, however, to select a different fastening for the restoring element or elements, for example a rigid fastening, in the case of which the tensile force can be adjusted in some other way.

The arrangement can be integrated particularly preferably in a mount of the tremolo, in particular of a height-adjustable tremolo, in the basic body of the stringed instrument. As a result, the arrangement is coupled to the tremolo movement and, when there is a change in position of the latter, likewise changes its position, as a result of which the tremolo can be arrested in the basic body of the stringed instrument by means of the arrangement. The arrangement is thus formed by means for arresting the mount of the tremolo in the basic body of the stringed instrument, or has these means, in particular in the form of the deflecting device(s) thereof.

Alternatively, it is possible for the at least one deflecting device to be fastened in the basic body without being connected directly to the tremolo. This proves to be particularly advantageous when the arrangement is used with non-height-adjustable tremolos, since there is no need for the deflecting device to be integrated in the mount of the tremolo and independent mounting of the two is thus possible. For the position of the arrangement, it is thus possible to select a suitable location within the basic body at which, although on the one hand the arrangement can perform a function, on the other hand the player's freedom is not restricted or indeed obstructed. Fastening particularly preferably takes place via adjusting elements, in particular one or more, in particular two, threaded sleeves. These are incorporated rigidly at a suitable location in the basic body and constitute the mount for the deflecting device of the arrangement.

It is particularly preferable for the restoring element or elements to be spring elements, in particular helical springs, or pneumatic or hydraulic cylinders. The use of spring elements, preferably tension springs, is particularly appropriate in most cases on account of the low cost. When hydraulic or pneumatic cylinders are used, the rigid body of the latter, in combination with the damping properties, may appear expedient in part in particular for installation in the relatively large stringed instruments in the case of which the weight-related advantage of the spring elements is not so important.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows a perspective view of an electric guitar with a tremolo together with an arrangement according to the invention;

FIG. 2 shows a sectional view of the tremolo of FIG. 1 together with a first embodiment of an arrangement according to the invention;

FIG. 3 shows a plan view of a second embodiment of an arrangement according to the invention;

FIG. 4 shows a schematic diagram of the arrangement according to FIG. 3 with the distribution of the stress resultants depicted; and

FIG. 5 shows a side view of the deflecting device according to FIG. 2.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENT

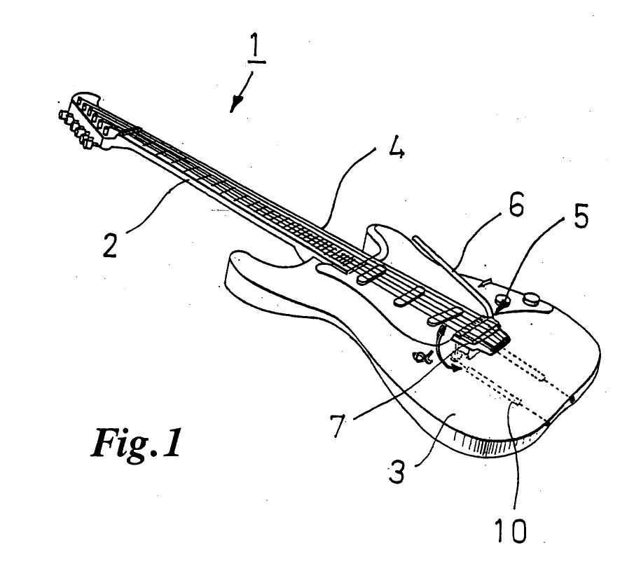

FIG. 1 shows a perspective view of a guitar 1 with a guitar neck 2, a basic body 3, strings 4 and a tremolo 5 with hand lever 6 and an arrangement 10, indicated by dashed lines, for producing a restoring force in the case of the tremolo. The arrangement 10 is arranged beneath the tremolo, or the base plate 7 thereof, at an angle of approximately α=0° to the strings, that is to say in extension thereof. The strings 4 are fastened on the base plate of the tremolo with adjustable tensioning.

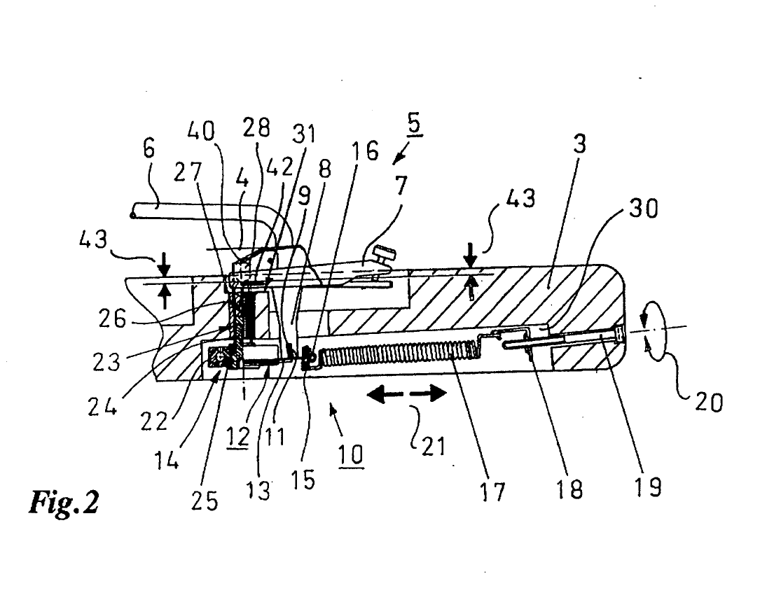

A detailed illustration of the arrangement can be seen in the following figures. FIG. 2 shows a sectional view through the tremolo 5 and the arrangement 10. The hand lever 6 of the tremolo is merely illustrated in part, as is a string 4.

The tremolo is provided, beneath its base plate 7, with an essentially vertical strut 8, which is fastened on said base plate and has one or more holes 9 at its bottom end, oriented away from the base plate. A segment 11 of a cable mechanism 12 of the arrangement 10, said segment being curved upwards in the direction of the strut 8, engages in said holes 9. The curved segment is connected to a cable 13 of the cable mechanism or is integral therewith and is guided around a deflecting device 14. The cable 13 ends in a connecting device for connection to a restoring element 17, which is designed as a helical spring, the connecting device having, in particular, a spring holder 15 and a deflecting cable pull 16 for deflecting and fastening of the cable 13. At its other end, the restoring element 17 is connected via a further connecting device, in particular in the form of a spring claw 18, to a tensioning screw 19, which makes it possible to tension and adjust the spring force of the restoring element. This is indicated by the double arrow 20, and the adjustability of the restoring element is indicated by the double arrow 21.

The entire arrangement is introduced into a recess 30 of the basic body 3, only part of the deflecting device 14 and the restoring element being located in the recess and the rest of the deflecting device being introduced into the basic body itself. The deflecting device 14 itself can better be seen from the illustration in detail form in FIG. 5. It has a ball bearing 22 and a fastening body 23 for fastening the ball bearing in the basic body 3 of the guitar or of the instrument in general. The ball bearing is fastened on the fastening body 23, in the case illustrated, by a holder 24 and a flat threaded nut 25, although it is also basically possible to use any other desired fastening which secures the ball bearing and fixes it on one side.

The holder 24 is adjoined by a guide screw 26, which is mounted in a threaded sleeve 27 together with the holder, which preferably has an external thread. The guide screw and holder may be provided as two separate parts or in one piece. The threaded sleeve 27 is introduced firmly into the basic body 3, in particular is fastened therein by a press fit. At that end of the threaded sleeve which is directed away from the ball bearing, a further recess 31 is provided in the basic body, into which recess the guide screw 26 projects and the base plate 7 of the tremolo 5 is introduced. There, the guide screw 26 engages in and/or through the base plate. On the top side of the base plate, the guide screw 26 projects by way of a thread-free segment 28. The latter has a hexagon socket 29 in which a tremolo fastening device 40 for the strings 4 can engage, said fastening device being fastened on the base plate. A narrowed region 41 is provided between the externally threaded segment of the guide screw and the segment which is provided with a hexagon socket. For further fastening of the guide screw on the base plate of the tremolo, a knife edge 12 or the like may be introduced into said narrowed region. As a result, tilting is permitted during the height adjustment of the tremolo, and the arrangement is integrated in the tremolo, in the region of the base plate thereof, via the holder of the ball bearing and the guide screw. In the case of a height adjustment of the tremolo, the arrangement is adjusted together with the tremolo, as a result of which its position does not change in relation to the tremolo. On account of the ball bearing being provided on the underside of the holder, the tremolo is arrested in the basic body at the same time.

The ball bearing 22 is provided, in the region of its circumference, with an encircling groove 44, in which the cable 13 can be positioned. This provides a better grip of the cable on the ball bearing and improved force deflection via the cable and ball-bearing combination, which acts as a unit. Instead of the groove 44, for this purpose, it is also possible to use some other suitable means, for example positioning ridges or the like.

The two double arrows 43 in FIG. 2 indicate the height-adjusting and tilting possibilities of the tremolo and the range in which this can take place. It is advantageously possible here for the base plate to be lowered to a very low level into the recess 31 of the basic body, as a result of which it is barely possible for parts projecting beyond the surface of the basic body to obstruct, and/or even injure, a player when playing. As in the example illustrated, it is also possible for the base plate to be of additionally comparatively flat design. The recess 31 is provided with a shoulder, as a result of which the rear thickened segment of the base plate and also the strut 8 can easily be lowered into the same. The underside of the basic body may be provided, in the region of the recess 30, with a covering plate, although this is not shown in FIG. 2.

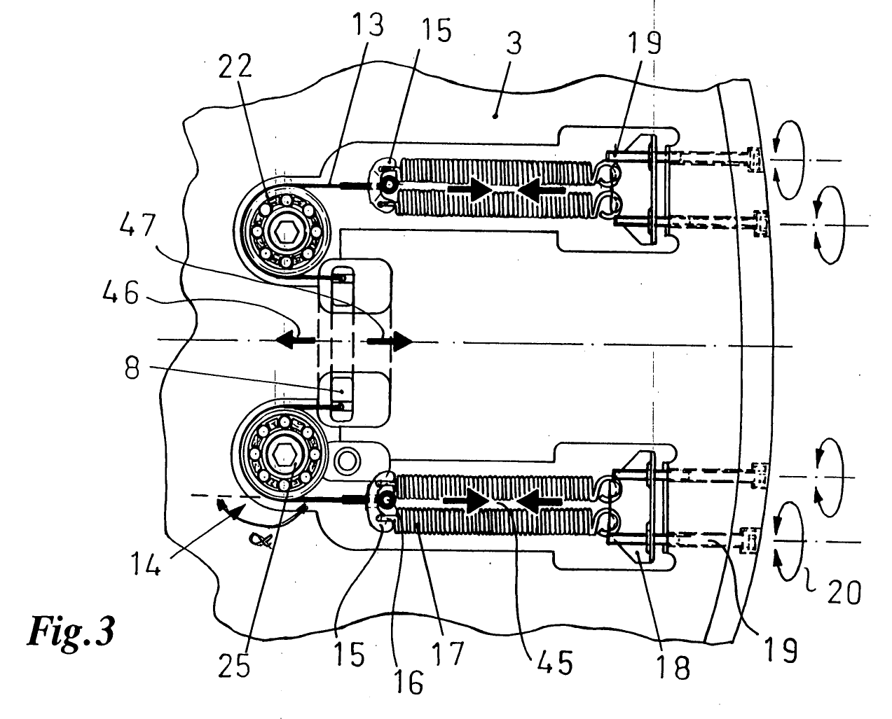

FIG. 3 illustrates a plan view of a further embodiment of the arrangement for producing a restoring force. Instead of just one or two restoring elements or helical springs 17, in each case two restoring elements are provided for each deflecting device 14, that is to say a total of four restoring elements are provided, in the case of this embodiment. The pairs of restoring elements formed here are pretensioned in the opposite direction, as can be gathered from the double arrows 45, to the single restoring element or elements according to FIG. 2. This is because of their paired relation and arrangement and action on the spring holders 15 and/or spring claws 18. Moreover, the respective restoring elements preferably have essentially the same pretensioning, in order to avoid bracing of the arrangement.

When the pretensioning of the restoring elements is adjusted by means of the tensioning screws 19, of which one is provided for each restoring element, uniform adjustment should likewise be ensured. In this case, as is indicated by the arrows 46, 47 in FIG. 3, the vertical strut 8 of the tremolo is moved in the direction of the strings (arrow 46) or of the opposite end of the basic body 3 (arrow 47). The height adjustment of the tremolo takes place as a result, which can better be seen from the attachment of the base plate of the tremolo in the region of the guide screw 26 (FIG. 2).

The deflecting angle for the cables 13 may be selected freely in principle. An angle of α=0° is selected in the case shown in FIG. 3. However, for example, deflecting angles of approximately 0°<α<+/−180° are also possible. The deflecting angle α may be selected in dependence on the construction of the instrument. In each case, for selection of the deflecting angle, it should be ensured that the restoring elements are arranged outside the region of the free strings, in order not to obstruct the capability for playing the latter.

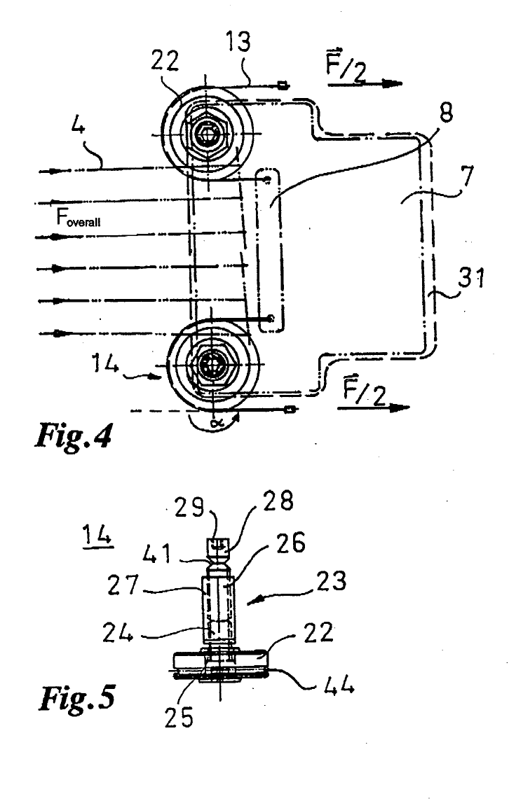

A schematic diagram of the action of the arrangement according to the invention when two deflecting devices 14 are used is shown in FIG. 4. If, for example, the strings 4 subject the tremolo to an overall string tensioning of Fₒᵥₑᵣₐₗₗ=500N and this tensioning is transmitted to two deflecting devices, a force of F/2=250N in each case occurs in the two cables 13, in particular steel cables or strings. This force is transmitted via the two ball bearings 22, which deflect the direction of action of the tensile stressing and thus advantageously allow the restoring elements, in particular tension springs, to be installed in any desired position, and is transmitted to said restoring elements, with the lowest possible level of frictional losses.

In the case of the embodiments illustrated in FIGS. 2 and 3, the deflecting device 14 is integrated in each case in the mount of the tremolo, as a result of which the two do not change in position in relation to one another. In another embodiment, however, it is possible to provide a non-height-adjustable tremolo, in the case of which it is not necessary for the position of the deflecting device to be changed together with the tremolo. The deflecting device may thus be installed rigidly in the basic body 3 of the instrument via the threaded sleeves 27 or other installation devices. This does away with the direct connection between the tremolo and deflecting device 14. The location for installing the installation devices for fastening the deflecting device(s) may be selected as desired and, in particular, may be at a location at which the deflecting device does not constitute an obstruction to the capability of playing the strings of the instrument freely and also does not distort the sound of the instrument.

Instead of the restoring elements in the form of tension springs such as shown in FIGS. 2 and 3, it is also possible to provide pneumatic or hydraulic cylinders as means for transmitting tensile stressing. The attachment to the cable mechanism and the basic body and/or an adjusting device for adjusting a desired prestressing of the pneumatic or hydraulic cylinders takes place here in a suitable manner. Instead of providing a ball bearing for reducing frictional losses during the deflection of the cable mechanism, it is also possible to use some other suitable means for deflecting purposes with this property. It is also possible for the cable mechanism itself to be replaced by a means which acts correspondingly, as long as force or tensile-stressing deflection can take place in combination with a deflecting device and at least one restoring element.

A suitable material for the cables 13 is, in particular, steel or some other material which is stable under tension, in particular also a fibrous material with corresponding tensile strength. Electrically conductive material is usually used for electric guitars. When springs, in particular steel springs, are used as the restoring elements, the spring force thereof is preferably selected in accordance with the tensile force which it is necessary to apply in the individual case, in particular in dependence on the maximum string tensioning. The tensioning screws and/or adjusting or tensioning devices for setting and adjusting the pretensioning of the restoring elements should have a suitable strength and size or dimensions and consist of a stable material which is suitable for installation in a respective basic body of the stringed instrument.

In addition to those variants of the arrangement according to the invention for producing a restoring force which has been described above and illustrated in the drawings, any other desired embodiments may also be formed. In this respect, the embodiments described are merely given by way of example. There are also numerous other possible variants in the case of which the arrangement is provided with at least one restoring element which is arranged in the basic body of a stringed instrument such that at any rate it is not arranged in the direction of the playable strings, that is to say it is not arranged parallel to, and beneath, the strings in the playable region of the latter, but rather is arranged in the basic body of the stringed instrument such that it is directed away from said region of the strings.

The arrangement according to the invention has considerable advantages over the arrangements of the prior art. Thus, sounds are produced more quickly on account of the notched sustain block. This does away with the otherwise conventional hole in the centre and results in a continuous centre block or body without interrupted longitudinal fibres. Along the wood fibre, depending on the type of wood, the sound-propagation speed is 1.8 to 2.8 times quicker than in the direction transverse to the wood fibre. In addition, in the region beneath the pickups and the electronics compartment, the additional wooden constituents contribute to better sounds being produced.

The arrangement according to the invention also has an improved string-resonation time, in particular because considerably more wood is present in the region of the electronics compartment, approximately ten times the quantity beneath the pickup.

Furthermore, the feedback sensitivity of the magnetic pickups is lower since all the ferromagnetic parts such as springs, spring plates and retaining screws, which are usually fitted a few millimetres beneath the pickups, have been shifted into the rear part of the guitar body and thus cannot influence the pickups any longer. A further advantage is the considerable increase in the tuning stability. This is achieved by a more rigid body structure by virtue of considerably greater proportions of wood in the regions where forces have a stabilizing action. Furthermore, this also results in the elimination of the pivoting effect or bending effect to which the tension springs are subjected when a tremolo effect is produced by means of hand-lever actuation, because the sustain block of the tremolo is pivoted away not just in the rearward direction, but also in the upward direction about the point of suspension of the tremolo-retaining screws. The pivoting effect, rather than acting any longer on the tension springs, now acts on the flexible bass strings, which act in the manner of a cable pull and the changes in angle of which are well absorbed via the V-belt-like guide grooves in the ball bearings. The tension springs are thus only subjected to tensile loading.

The damping effect of secondary noise is also improved. Secondary noise produced beyond the strings and the tremolo, for example the buzzing or vibrating noise of tension springs or the retaining or fastening elements thereof, is damped by the plastic ball bearings and is no longer transmitted to the tremolo and parts located behind the latter, such as the strings. The spring force can be readjusted from the outside, and there is no need for coverings to be removed beforehand. Furthermore, it is possible to adjust different spring pretensionings, which is not insignificant for frequently used sets of playing strings in the case of which the bass strings are pretensioned with more force than the thinner lead strings. In this case, it is also expedient to set a greater level of opposing spring pretensioning on the side on which the bass-playing strings are located, in order to counteract the action of the movable tremolo tilting. This is achieved by two separate spring chambers and two independent spring mounts.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. Stringed instrument (1), in particular a plucked instrument, such as a guitar, with a basic body (3) and strings (4), having an arrangement (10) for producing a restoring force in the case of a tremolo (5) using at least one restoring element (17), the at least one restoring element (17) being arranged in an adjustable manner in the basic body (3) of the stringed instrument (1) outside the region of the free strings (4), characterized by the provision of a notched sustain block (8) of the tremolo (5) and a thus possible continuous center block or body of the stringed instrument (1) without interrupted longitudinal fibers.

2. Stringed instrument (1) according to claim 1, characterized in that the at least one restoring element (17) is arranged essentially in the direction of, and/or at an angle α to, the strings (4).

3. Stringed instrument (1) according to claim 1 or 2, characterized in that the restoring element or elements (17) is or are operatively connected to the tensioning of the strings (4) via a force-deflecting device (12, 14), deflection of the spring tensioning taking place in the direction of and/or transversely to, in particular at an angle of 0°<α<180° to, the latter [sic].

4. Stringed instrument (1) according to claim 3, characterized in that the force-deflecting device has a cable-pull mechanism (12) in combination with at least one deflecting device (14).

5. Stringed instrument (1) according to claim 4, characterized in that the deflecting device (14) has low-friction deflection of the cable-pull mechanism, in particular using a running bearing, in particular a ball bearing (22).

6. Stringed instrument (1) according to one of the preceding claims, characterized in that the deflecting angle α of the cable pull, this angle being produced by the deflecting device (14), may be selected in dependence on the shape of the basic body (3) of the stringed instrument (1).

7. Stringed instrument (1) according to one of claims 2 to 5, characterized in that the arrangement (10) can be integrated in a mount of the tremolo (5), in particular of a height-adjustable tremolo, in the basic body (3) of the stringed instrument (1).

8. Stringed instrument (1) according to claim 7, characterized in that the arrangement (10) has means (22, 23, 25, 26, 27) for arresting the mount of the tremolo (5) in the basic body (3) of the stringed instrument (1).

9. Stringed instrument (1) according to one of claims 1 to 6, characterized in that the at least one deflecting device (14) can be fastened in the basic body (3) without being connected directly to the tremolo (5), in particular when used with a non-height-adjustable tremolo (5).

10. Stringed instrument (1) according to one of claims 7 to 9, characterized in that the deflecting device (14) is fastened in the basic body (3) via adjusting elements, in particular threaded sleeves (27).

11. Stringed instrument (1) according to one of the preceding claims, characterized in that the restoring elements (17) can be adjusted on one side via a tensioning screw (19) mounted in the basic body (3) of the stringed instrument (1).

12. Stringed instrument (1) according to one of the preceding claims, characterized by the provision of a means (19) for readjusting the spring force of the restoring element or elements (17) from the outside.

13. Stringed instrument (1) according to one of the preceding claims, characterized in that one deflecting device. (14) can be connected to a plurality of restoring elements (17).

14. Stringed instrument (1) according to one of the preceding claims, characterized in that it is possible to adjust different spring pretensionings of the restoring elements (17), in particular two separate spring chambers and two independent spring mounts are provided.

15. Arrangement (10) for producing a restoring force in the case of a tremolo (5) for a stringed instrument (1) according to one of the preceding claims, characterized by the provision of restoring elements (17) which exert and/or transmit tensile stressing, it being possible to adjust in particular different spring pretensionings.

16. Arrangement (10) according to claim 15, characterized in that the restoring elements (17) are spring elements, in particular helical springs, or pneumatic or hydraulic cylinders.
